(19) United States
(12) Patent Application Publication
(10) Pub. No.: US 2008/0106138 A1
(43) Pub. Date: May 8, 2008

(54) WEAR-RESISTANT CUTTING BIT

(76) Inventor: Xiaojun YANG, Shijiazhuang (CN)

Correspondence Address: MATTHIAS SCHOLL, 14781 MEMORIAL DRIVE, SUITE 1319, HOUSTON, TX, 77079, US

(21) Appl. No.: 11/935,434

(22) Filed: Nov. 6, 2007

(30) Foreign Application Priority Data
Nov. 6, 2006 (CN) 200610102129.9

(51) Int. Cl. B25D 17/02

(52) U.S. Cl. 299/104

(57) ABSTRACT

Taught is a wear-resistant cutting bit for breaking or excavating machines, comprising a carbide alloy bit tip and a bit body, wherein a plurality of wear-resistant members is installed on the bit body around the carbide alloy bit tip. In accordance with the present invention, the strength, hardness, and wear resistance of the bit body are improved largely, alleviating conventional problems of wear and fatigue and reinforcing the attachment of the bit tip. The early failure of the bit tip due to the premature wear of the bit body is overcome; and the lifetime of the bit is increased 2 to 3-fold with respect to that of a conventional bit.

### CROSS-REFERENCE TO RELATED APPLICATIONS

This application claims priority to Chinese Patent Application No. 220610102129.9 filed on Nov. 6, 2006, the contents of which are incorporated herein by reference.

### BACKGROUND OF THE INVENTION

1. Field of the Invention

The invention relates to cutting bits for wall breaking, tunneling, trenching, coal mining, and road milling machines, and more particularly to wear-resistant cutting bits.

2. Description of the Related Art

Bits for breaking or excavating machines are generally comprised of an alloy steel bit body and a carbide alloy bit tip. The carbide alloy bit tip is welded to the head of the bit body using soldering technology. During cutting or breaking operation, the head of the cutter is strongly squeezed and subjected to friction. Thus, the bit body around the carbide alloy bit tip will wear out, generally resulting in the falling off of and catastrophic damage to the bit tip.

### SUMMARY OF THE INVENTION

Therefore, it is one objective of the present invention to provide a wear-resistant bit for breaking or excavating machines capable of increasing the wear resistance and strength of the bit body so as to extend the useful life of the bit.

To achieve the above objective, there is provided a wear-resistant bit, comprising a carbide alloy bit tip and a bit body, wherein a plurality of wear-resistant members is installed on the bit body around the carbide alloy bit tip.

In certain embodiments of the present invention, the carbide alloy bit tip is in the shape of a cylinder with tapered tip, a multihedral prism, a mushroom, a bi-conical polyhedron, a bell, or the like.

In certain embodiments of the present invention, the wear-resistant member is in the shape of a cylinder, a frustum, a truncated cone, a rectangular parallelepiped, a multihedral prism, a cone, or the like, and its size is chosen according to the shape and size of the carbide alloy bit tip.

In certain embodiments of the present invention, the wear-resistant member is a sheet body.

In certain embodiments of the present invention, the number of the wear-resistant members installed on the bit body around the bit tip is in the range of 3 to 50, and optimally, in the range of 6 to 20.

In certain embodiments of the present invention, the bit body around the carbide alloy bit tip comprises 2-50 pieces of wear-resistant members.

As a result, in accordance with the present invention, the strength, hardness, and wear resistance of the bit body are improved largely, alleviating conventional problems of wear and fatigue and reinforcing the attachment of the bit tip. The early failure of the bit tip due to the premature wear of the bit body is overcome; and the lifetime of the bit is increased 2 to 3-fold with respect to that of a conventional bit.

### BRIEF DESCRIPTION OF THE DRAWINGS

FIG. 1 is a structural view of a bit body installed with cylindrical wear-resistant members according to one embodiment of the present invention;

FIG. 2 is a structural view of a bit body installed with rectangular wear-resistant members according to one embodiment of the present invention;

FIG. 3 is a structural view of a bit body installed with sheet-shaped wear-resistant members according to one embodiment of the present invention;

FIG. 4 is a structural view of a bit body installed with cylindrical and sheet-shaped wear-resistant members according to one embodiment of the present invention;

FIG. 5 is a structural view of a mushroom-shaped bit tip according to one embodiment of the present invention;

FIG. 6 is a structural view of a bi-conical polyhedron-shaped bit tip according to one embodiment of the present invention; and

FIG. 7 is a structural view of bell-shaped bit tip according to one embodiment of the present invention.

The reference numbers of the various parts shown in the drawings are listed below, in which carbide alloy bit tip corresponds to the number 1; bit body—2; and wear-resistant member—3.

### DETAILED DESCRIPTION OF THE EMBODIMENTS

The present invention will hereinafter be described further according to the embodiments.

As shown in the Figures, a wear-resistant bit comprises a carbide alloy bit tip 1 and a bit body 2. A plurality of wear-resistant members 3 is installed on the bit body 2 around the carbide alloy bit tip 1. The wear-resistant member 3 can be in a shape of cylinder, a rectangular parallelepiped, a multihedral prism, a sheet body, a cone, or the like.

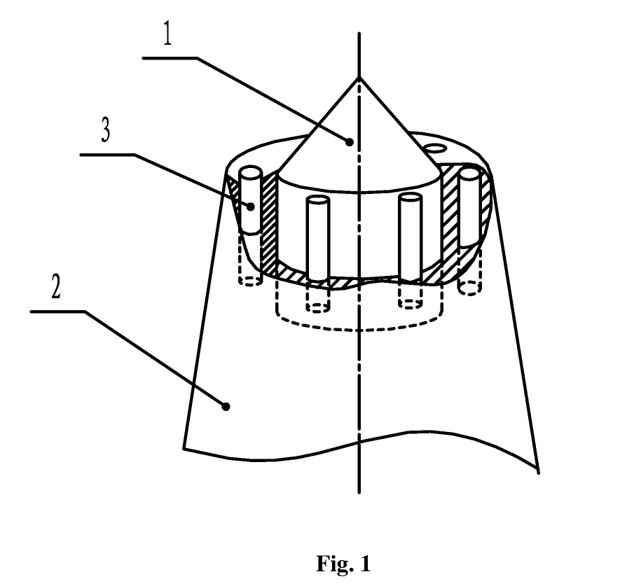

FIGS. 1-7 illustrate a bit model JGC102/35 in accordance with the present invention. As shown in FIG. 1, 6 pieces carbide alloy cylinders acting as wear-resistant members are installed uniformly around the carbide alloy bit tip 1. The cylinder has a diameter of 3.5 mm and a height of 15 mm.

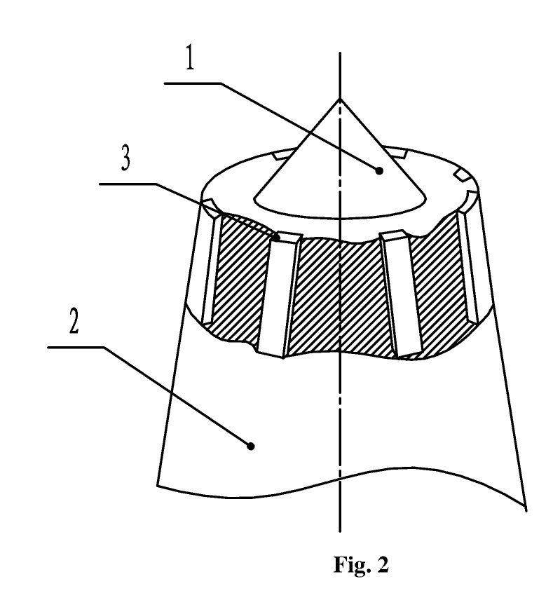

FIG. 2 illustrates a rectangular wear-resistant member 3 installed on the bit body 2.

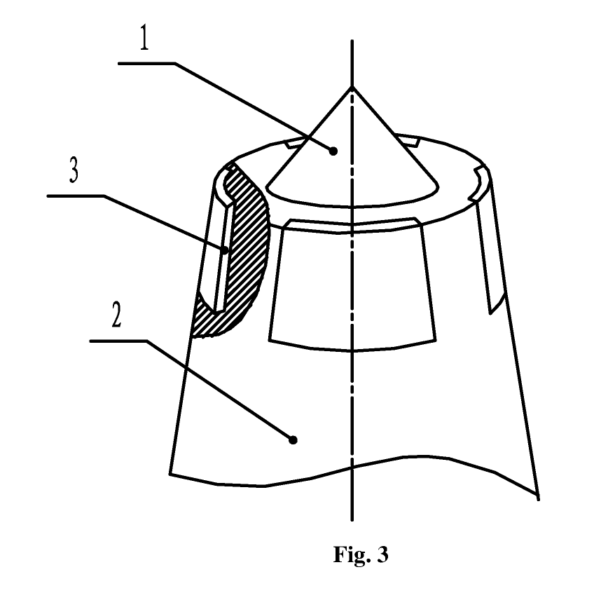

FIG. 3 illustrates a sheet-shaped wear-resistant member 3 installed on the bit body 2.

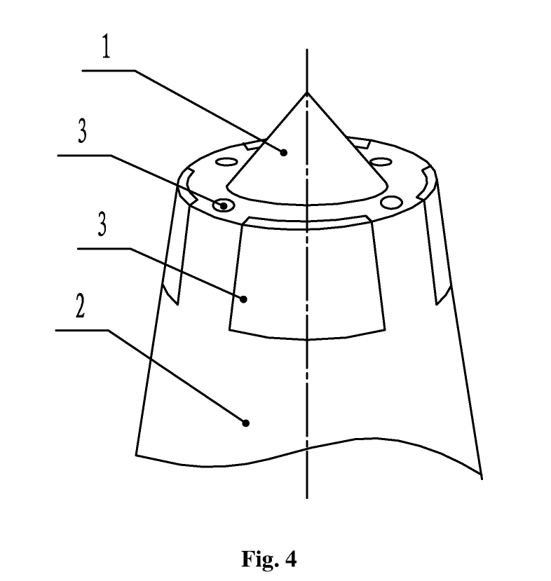

FIG. 4 illustrates both cylindrical and sheet-like wear-resistant members 3 installed on the bit body 2. The sheet body can be in a shape of an arc or plate. The wear-resistant member 3 is installed on the bit body 2 by welding, screwing, riveting, or the like.

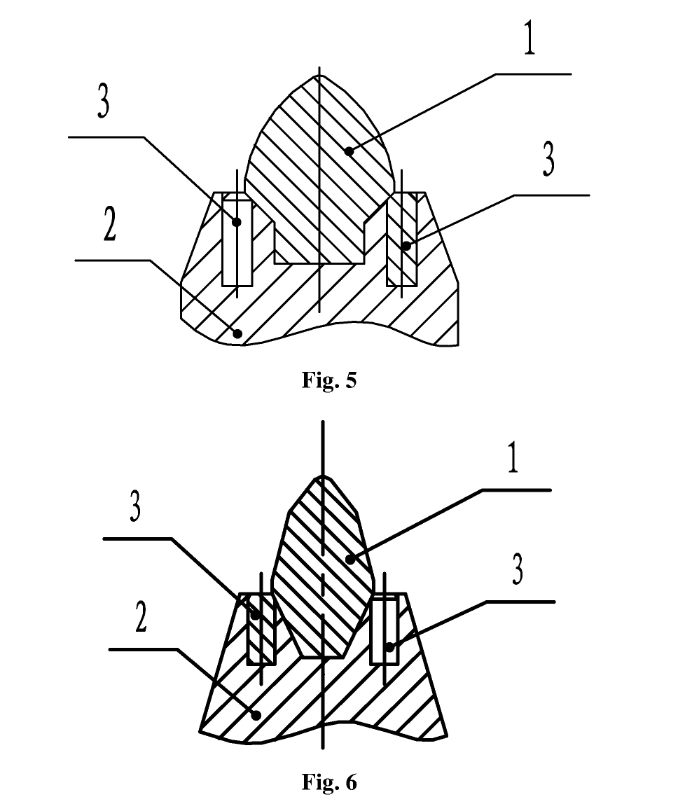

FIG. 5 illustrates a mushroom-shaped bit tip of the present invention. The wear-resistant member 3 intersects with an extended conical surface of the maximum axial outline of the bit tip 1.

FIG. 6 illustrates a bi-conical polyhedron-shaped bit tip 1 of the present invention.

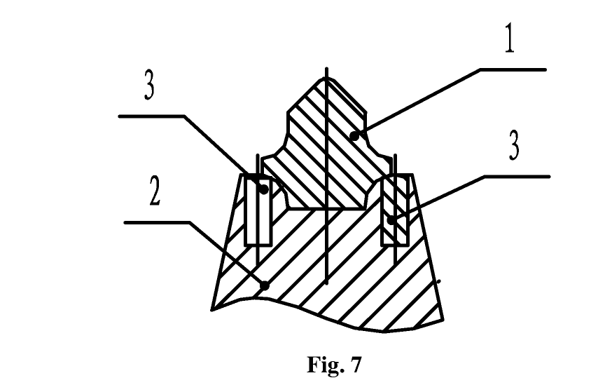

FIG. 7 illustrates a bell-shaped bit tip 1. The wear-resistant member 3 intersects with an extended conical surface of the maximum axial outline of the bit tip 1.

With respect to the bit tips illustrated in FIG. 5 and FIG. 7, the size of the front face of the bit is decreased, so that the operational resistance of the bit is reduced, the vibration and dust emission are lowered, and meanwhile, the exposure of the wear-resistant member 3 to the material to be broken up or excavated is reduced. Thus, the wear-resistant member 3 is protected effectively.

Similarly, if the front protruded conical surface of the bi-conical polyhedron-shaped bit tip 1 illustrated in FIG. 6 is extended, the functions as illustrated in FIG. 5 and FIG. 7 are realized.

Although the present invention has been described in connection with preferred embodiments thereof, it will be appreciated by those skilled in the art that additions, modifications, substitutions and deletions not specifically described may be made without departing from spirit and scope of the invention as defined in the claims.

What is claimed is:

1. A wear-resistant bit for breaking or excavating machines comprising
a bit body (2);
a bit tip (1); and
a plurality of wear-resistant members (3),
wherein
said bit tip (1) is made of a first material, said wear-resistant member (3) is made of a second material, and said bit body (2) is made of a third material;
said first material is harder than said third material;
said second material is harder than said third material; and
said wear-resistant members (3) are disposed on said bit body (2) and/or said plurality of wear-resistant members (3) are disposed in said bit body (2).

2. The bit of claim 1, wherein said wear-resistant members (3) are disposed on the bit body (2) around the carbide alloy bit tip (1).

3. The bit of claim 1, wherein said wear-resistant members (3) are in a shape of a cylinder, a truncated cone, a frustum, a rectangular parallelepiped, a multihedral prism, a cone, or a sheet.

4. The bit of claim 2, wherein said wear-resistant members (3) are in a shape of a cylinder, a truncated cone, a frustum, a rectangular parallelepiped, a multihedral prism, a cone, or a sheet.

5. The bit of claim 1, wherein the number of the wear-resistant members (3) is in a range of 3 to 50.

6. The bit of claim 2, wherein the number of the wear-resistant members (3) is in a range of 3 to 50.

7. The bit of claim 5, wherein the number of the wear-resistant members (3) is in a range of 6 to 20.

8. The bit of claim 6, wherein the number of the wear-resistant members (3) is in a range of 6 to 20.

9. The bit of claim 1, wherein said wear-resistant members (3) are sheet bodies.

10. The bit of claim 2, wherein said wear-resistant members (3) are sheet bodies.

11. The bit of claim 9, wherein between 2 and 50 pieces of wear-resistant members (3) are disposed on said bit body (2) around said carbide alloy bit tip (1).

12. The bit of claim 10, wherein between 2 and 50 pieces of wear-resistant members (3) are disposed on said bit body (2) around said carbide alloy bit tip (1).

13. The bit of claim 1, wherein said first material and said second material are the same.

14. The bit of claim 1, wherein said first material and said second material are different from one another.

15. The bit of claim 1, wherein said first material is carbide alloy, said second material is carbide alloy, and said third material is alloy steel.
